(19) United States
(12) Patent Application Publication
(10) Pub. No.: US 2018/0225364 A1
(43) Pub. Date: Aug. 9, 2018

(54) INFORMATION OUTPUT METHOD AND INFORMATION OUTPUT APPARATUS

(71) Applicant: FUJITSU LIMITED, Kawasaki-shi (JP)

(72) Inventor: Kenichi HANADA, Moriguchi (JP)

(73) Assignee: FUJITSU LIMITED, Kawasaki-shi (JP)

(21) Appl. No.: 15/849,426

(22) Filed: Dec. 20, 2017

(30) Foreign Application Priority Data
Feb. 9, 2017 (JP) 2017-022371

(51) Int. Cl. G06F 17/30; G06F 17/28; G06F 17/27; G06Q 30/02; G06Q 50/00

(52) U.S. Cl. CPC G06F 17/30663; G06F 17/30713; G06F 17/28; G06Q 50/01; G06F 17/2795; G06Q 30/0278; G06F 17/2735

(57) ABSTRACT

An information output method in which a computer is made execute processing includes acquiring a character string corresponding to identification information representing a product when the identification information representing the product is acquired, collecting information including the character string, referring to a storage configured to store a forbidden word corresponding to the character string, specifying information that does not include the forbidden word corresponding to the character string among the information that are collected, and outputting the information that does not include the forbidden word corresponding to the character string.

### CROSS-REFERENCE TO RELATED APPLICATION

This application is based upon and claims the benefit of priority of the prior Japanese Patent Application No. 2017-022371, filed on Feb. 9, 2017, the entire contents of which are incorporated herein by reference.

### FIELD

The embodiments discussed herein are related to an information output method and an information output device.

### BACKGROUND

A large number of texts such as impressions and opinions on various products are accumulated on the social networking service (SNS), and these pieces of information are often referred to by purchasers and developers of products. Here, a technique for extracting a part of review texts to be referred to by a person (analyst) from a large number of review texts posted on a mail order site or a word-of-mouth site on the Internet is well known (see International Publication Pamphlet No. WO 2013/161510 and Japanese Laid-open Patent Publication No. 2013-178754, for example).

### SUMMARY

According to an aspect of the invention, an information output method in which a computer is made execute processing includes acquiring a character string corresponding to identification information representing a product when the identification information representing the product is acquired, collecting information including the character string, referring to a storage configured to store a forbidden word corresponding to the character string, specifying information that does not include the forbidden word corresponding to the character string among the information that are collected, and outputting the information that does not include the forbidden word corresponding to the character string.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration example of a system according to a first embodiment;

FIG. 2 illustrates a functional configuration example of a mobile terminal and an information provision server according to the first embodiment;

FIG. 3 illustrates data configuration examples of various types of information;

FIG. 4 illustrates a hardware configuration example of the mobile terminal;

FIG. 5 illustrates a hardware configuration example of the information provision server;

FIG. 6 is a sequence diagram illustrating a processing example according to the first embodiment;

FIG. 7 illustrates a display example of public information in the mobile terminal;

FIG. 8 illustrates an example of imparting weights to dictionaries;

FIG. 9 illustrates a functional configuration example of the mobile terminal and the information provision server according to a second embodiment;

FIG. 10 is a sequence diagram illustrating a processing example according to the second embodiment;

FIG. 11 illustrates a functional configuration example of the mobile terminal and the information provision server according to a third embodiment;

FIG. 12 is a sequence diagram illustrating a processing example according to the third embodiment;

FIG. 13 illustrates a display example of public information in the mobile terminal;

FIG. 14 illustrates a functional configuration example of the mobile terminal and the information provision server according to a fourth embodiment; and

FIG. 15 is a sequence diagram illustrating a processing example according to the fourth embodiment.

### DESCRIPTION OF EMBODIMENTS

Texts on the SNS are sometimes referred to by purchasers of products. However, for example, it is common for Japanese purchasers to refer to texts written in Japanese by the Japanese for products made in Japan.

On the other hand, it is desirable to provide information on domestic products to foreigners due to current increase of opportunities of product purchase by foreign travelers. However, it is difficult for domestic staffs to prepare information for foreigners because their views for evaluating products are different from those of foreigners due to difference in national characters and the like and the staffs have to handle unfamiliar foreign languages. Therefore, though it is desirable to utilize information written in corresponding foreign languages on the SNS, there has been no system for appropriately providing information on domestic products written in foreign languages. Here, difference in languages is not taken into account in International Publication Pamphlet No. WO 2013/161510 and Japanese Laid-open Patent Publication No. 2013-178754 mentioned above.

According to one aspect, information corresponding to a product may be appropriately outputted.

Embodiments according to the present disclosure will be described below.

### First Embodiment

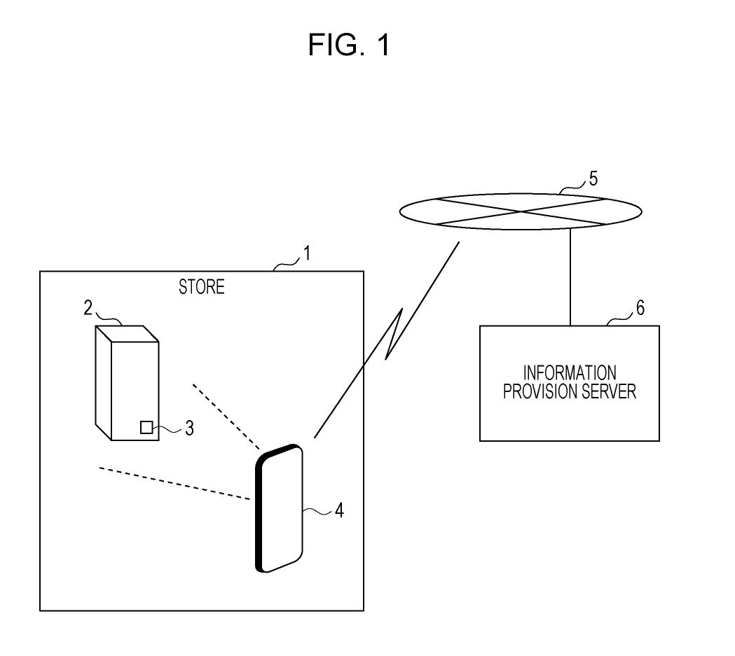

FIG. 1 illustrates a configuration example of a system according to the first embodiment. In FIG. 1, a code image 3 such as a two-dimensional code and a one-dimensional code in which a product code is embedded is attached to a product 2 displayed in a store 1. The code image 3 attached to the product 2 is readable by a camera function of a mobile terminal 4 such as a smartphone, a tablet, and a mobile phone which is obtained by a customer (assumed to be a foreign customer). Further, the mobile terminal 4 is communicable with an information provision server 6 via a network 5 such as a mobile radio network and the Internet.

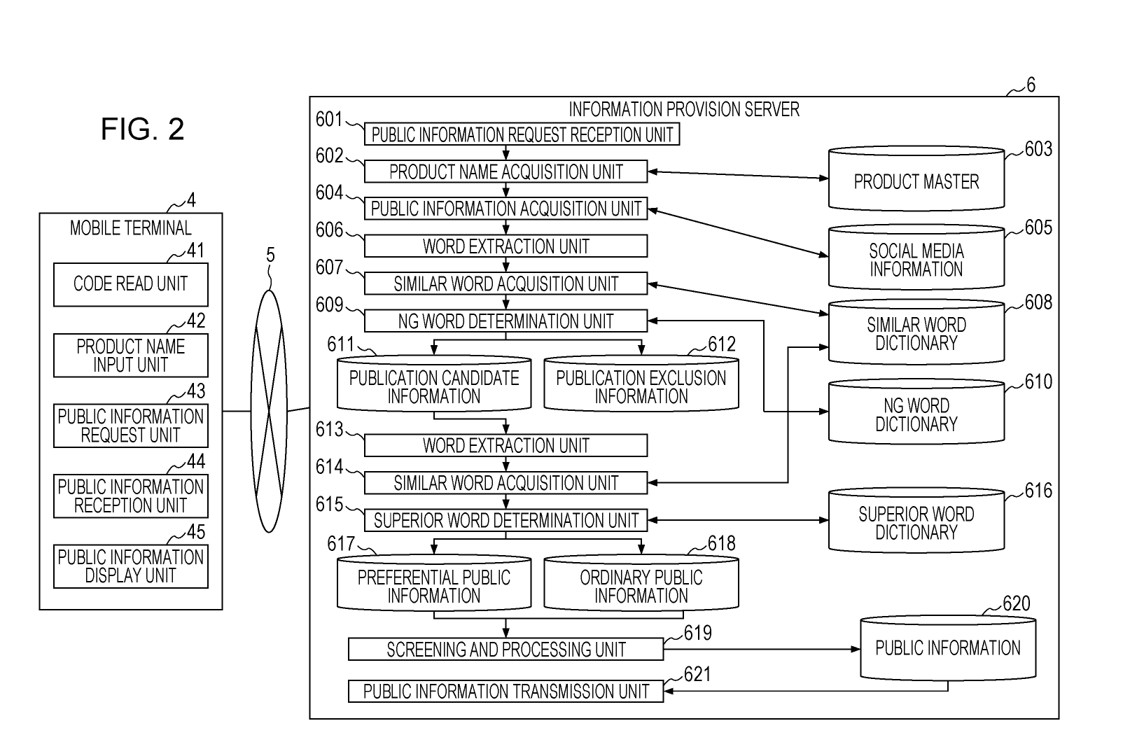

FIG. 2 illustrates a functional configuration example of the mobile terminal 4 and the information provision server 6 according to the first embodiment. In FIG. 2, the mobile terminal 4 includes a code read unit 41, a product name input unit 42, a public information request unit 43, a public information reception unit 44, and a public information display unit 45.

The code read unit 41 has a function for reading the code image 3 (FIG. 1), which is attached to the product 2, by using the camera function of the mobile terminal 4 so as to acquire a product code which is embedded. The product name input unit 42 has a function for receiving an input of a product name from a user instead of code reading. A product name is inputted in a language (Chinese, for example) used by the user. The public information request unit 43 has a function for transmitting a public information request accompanied with a product code acquired by the code read unit 41 or a product name received by the product name input unit 42 with respect to the information provision server 6. Public information is assumed to be based on a language (Chinese, for example) used by a user. This is because it is possible for the user to directly read the information and in addition, it is conceivable that texts posted by persons using a language same as that of the user are more useful because a viewpoint for evaluating products differs depending on national characters and the like. The public information reception unit 44 has a function for receiving public information transmitted from the information provision server 6 in response to a public information request. The public information display unit 45 has a function for displaying public information received by the public information reception unit 44.

Meanwhile, the information provision server 6 includes a public information request reception unit 601, a product name acquisition unit 602, a product master 603, a public information acquisition unit 604, and social media information 605. The information provision server 6 further includes a word extraction unit 606, a similar word acquisition unit 607, a similar word dictionary 608, an NG word determination unit 609, an NG word dictionary 610, publication candidate information 611, and publication exclusion information 612. The information provision server 6 furthermore includes a word extraction unit 613, a similar word acquisition unit 614, a superior word determination unit 615, a superior word dictionary 616, preferential public information 617, ordinary public information 618, a screening and processing unit 619, public information 620, and a public information transmission unit 621.

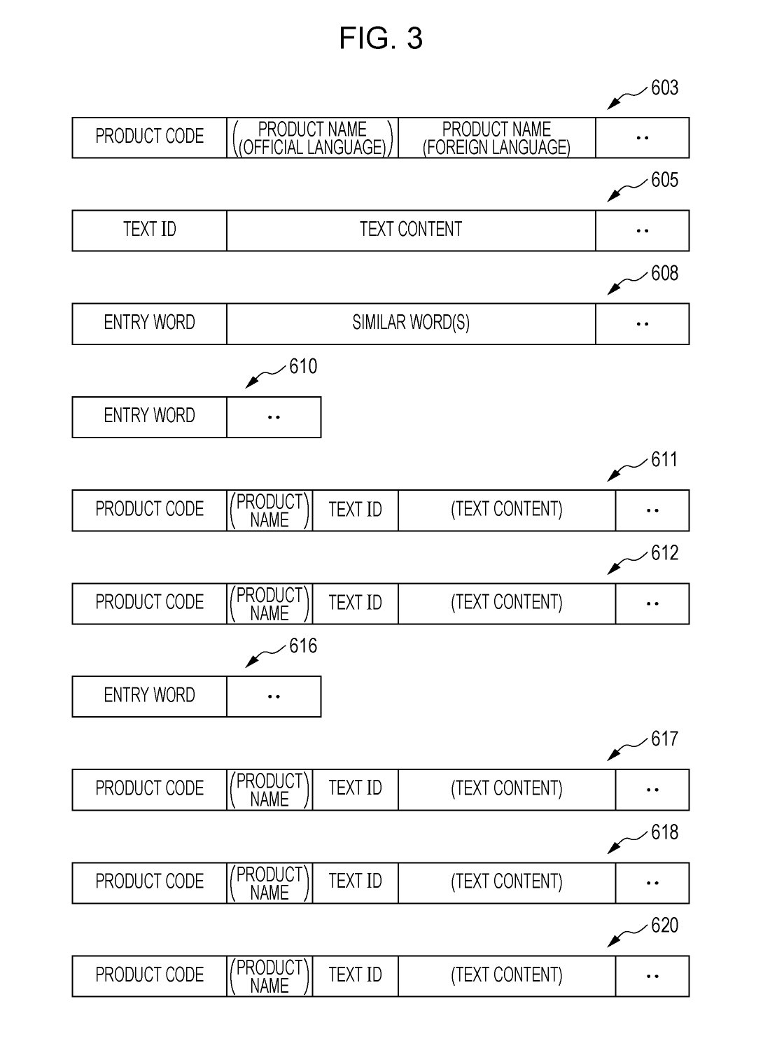

The public information request reception unit 601 has a function for receiving a public information request from the mobile terminal 4. The product name acquisition unit 602 has a function for referring to the product master 603 so as to acquire a product name in a foreign language (Chinese, for example), which is preliminarily translated, in the case where a public information request received by the public information request reception unit 601 is accompanied with a product code. The product master 603 includes items such as “product code”, “(product name (official language))”, and “product name (foreign language)”, as illustrated in FIG. 3. “(Product name (official language))” is a product name based on an official language (Japanese, for example) of a country (Japan, for example) where the store 1 (FIG. 1) exists. “Product name (foreign language)” is a product name based on a language (Chinese, for example) used by a foreign customer (Chinese, for example) assumed to be provided with the information.

Referring back to FIG. 2, the public information acquisition unit 604 has a function for retrieving the social media information 605 based on a product name attached to a public information request or a product name acquired by the product name acquisition unit 602 so as to acquire public information including the product name. The social media information 605 includes items such as “text ID” and “text content”, as illustrated in FIG. 3. “Text content” is information which are preliminarily collected from sites of the social networking service (SNS) and the like based on a language (Chinese, for example) used by a foreign customer (Chinese, for example) assumed to be provided with the information.

Referring back to FIG. 2, the word extraction unit 606 has a function for extracting an included word of individual texts in public information acquired by the public information acquisition unit 604. The similar word acquisition unit 607 has a function for referring to the similar word dictionary (synonym dictionary) 608 based on a word extracted by the word extraction unit 606 so as to acquire a similar word (synonym). The similar word dictionary 608 includes items such as “entry word” and “similar word(s)”, as illustrated in FIG. 3.

“Entry word” and “similar word(s)” are based on a language (Chinese, for example) used by a foreign customer (Chinese, for example) assumed to be provided with information.

Referring back to FIG. 2, the NG word determination unit 609 has a function for determining whether or not either one of a word extracted by the word extraction unit 606 and a similar word acquired by the similar word acquisition unit 607 corresponds to an NG word (forbidden word) registered in the NG word dictionary 610. That is, whether or not an NG word is included in individual texts of public information acquired by the public information acquisition unit 604 is determined, then, texts which do not include the NG word are held in the publication candidate information 611, and texts which include the NG word are held in the publication exclusion information 612. The NG word dictionary 610 includes items such as “entry word”, as illustrated in FIG. 3. “Entry word” is based on a language (Chinese, for example) used by a foreign customer (Chinese, for example) assumed to be provided with information. The publication candidate information 611 includes items such as “product code”, “(product name)”, “text ID”, and “(text content)”. “(Product name)” may be omitted because a product name is available by referring to the product master 603 based on a product ID. “(Text content)” may also be omitted because a text content is available by referring to the social media information 605 based on a text ID. The publication exclusion information 612 also includes items same as those of the publication candidate information 611.

Referring back to FIG. 2, the word extraction unit 613 has a function for extracting an included word from individual texts of the publication candidate information 611. The similar word acquisition unit 614 has a function for referring to the similar word dictionary (synonym dictionary) 608 based on a word extracted by the word extraction unit 613 so as to acquire a similar word (synonym). The superior word determination unit 615 has a function for determining whether or not either one of a word extracted by the word extraction unit 613 and a similar word acquired by the similar word acquisition unit 614 corresponds to a superior word (preferential word) registered in the superior word dictionary 616. That is, whether or not a superior word is included in individual texts of the publication candidate information 611 is determined, then, texts which include the superior word are held in the preferential public information 617, and texts which do not include the superior word are held in the ordinary public information 618. The superior word dictionary 616 includes items such as “entry word”, as illustrated in FIG. 3. “Entry word” is based on a language (Chinese, for example) used by a foreign customer (Chinese, for example) assumed to be provided with information. The preferential public information 617 and the ordinary public information 618 include items such as “product code”, “(product name)”, “text ID”, and “(text content)”.

Referring back to FIG. 2, the screening and processing unit 619 has a function for performing screening based on a predetermined pattern with respect to individual texts in the preferential public information 617 and the ordinary public information 618, performing processing such as removal of inappropriate parts, and holding resultant texts in the public information 620. Here, in the public information 620, texts based on the preferential public information 617 are separated so as to be preferentially published. The public information 620 includes items such as “product code”, “(product name)”, “text ID”, and “(text content)”, as illustrated in FIG. 3.

Referring back to FIG. 2, the public information transmission unit 621 has a function for transmitting (responding) the public information 620 with respect to the mobile terminal 4 which has issued a public information request.

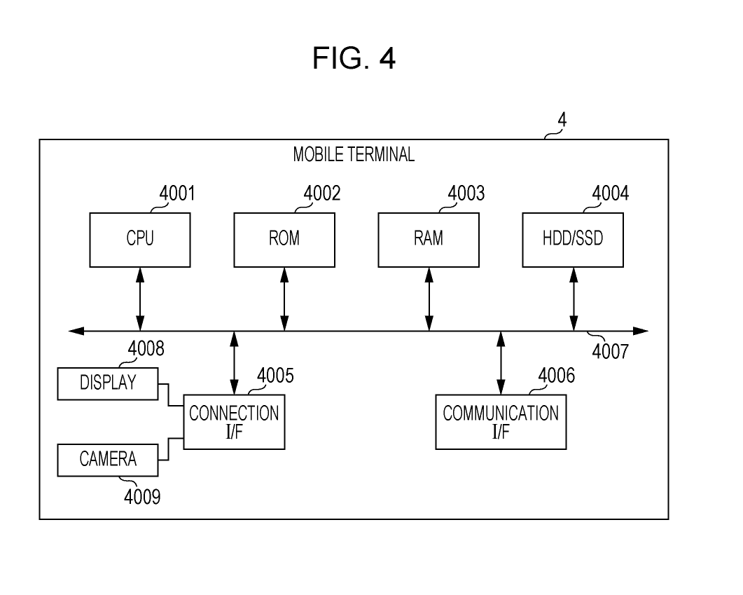

FIG. 4 illustrates a hardware configuration example of the mobile terminal 4. In FIG. 4, the mobile terminal 4 includes a central processing unit (CPU) 4001, a read only memory (ROM) 4002, a random access memory (RAM) 4003, and a hard disk drive (HDD)/solid state drive (SSD) 4004 which are mutually connected via a bus 4007. The mobile terminal 4 further includes a connection interface (I/F) 4005 and a communication I/F 4006, and a display 4008 and a camera 4009 which are connected to the connection I/F 4005.

The CPU 4001 executes a program stored in the ROM 4002 or the HDD/SSD 4004, for example, by using the RAM 4003 as a work area, thus comprehensively controlling an operation of the mobile terminal 4. The functions of the mobile terminal 4 described with reference to FIG. 2 are realized by executing a predetermined program in the CPU 4001. The program may be acquired via a recording medium, may be acquired via a network, or may be incorporated in the ROM.

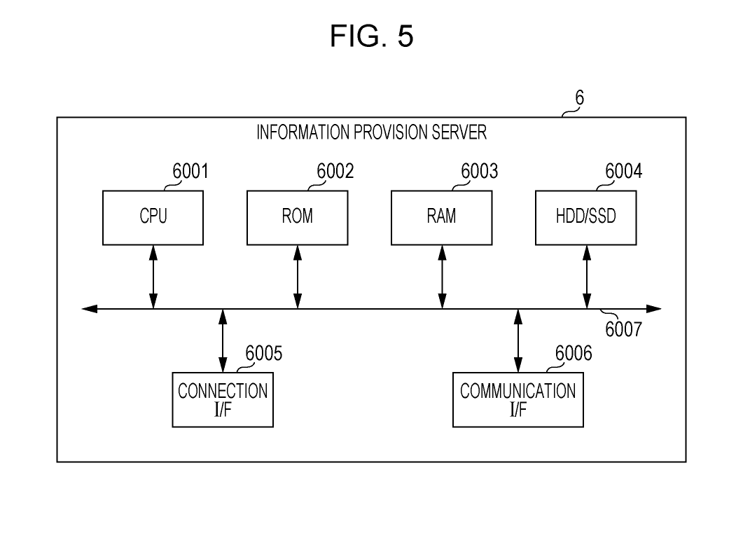

FIG. 5 illustrates a hardware configuration example of the information provision server 6. In FIG. 5, the information provision server 6 includes a CPU 6001, a ROM 6002, a RAM 6003, and a HDD/SSD 6004 which are mutually connected via a bus 6007. The information provision server 6 further includes a connection I/F 6005 and a communication I/F 6006.

The CPU 6001 executes a program stored in the ROM 6002 or the HDD/SSD 6004, for example, by using the RAM 6003 as a work area, thus comprehensively controlling an operation of the information provision server 6. The functions of the information provision server 6 described with reference to FIG. 2 are realized by executing a predetermined program in the CPU 6001. The program may be acquired via a recording medium, may be acquired via a network, or may be incorporated in the ROM.

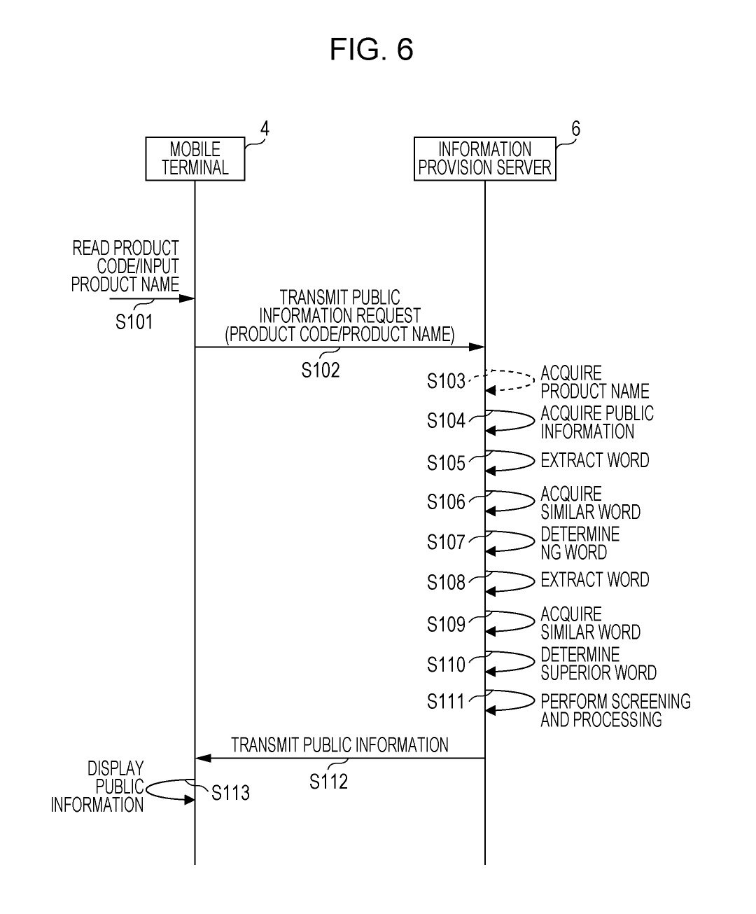

FIG. 6 is a sequence diagram illustrating a processing example according to the first embodiment. In FIG. 6, in response to an operation through the mobile terminal 4 by a foreign user who wants public information at the store 1, the code read unit 41 reads the code image 3 attached to the product 2 by using a camera function so as to acquire a product code. Further, the product name input unit 42 receives an input of a product name from the user instead of code reading (step S101).

Then, the public information request unit 43 transmits a public information request accompanied with the product code acquired by the code read unit 41 or the product name received by the product name input unit 42 with respect to the information provision server 6 (step S102).

When the public information request reception unit 601 of the information provision server 6 receives the public information request, in the case where the public information request is accompanied with the product code, the product name acquisition unit 602 refers to the product master 603 so as to acquire a product name in a foreign language (Chinese, for example) which is preliminarily translated (step S103).

Subsequently, the public information acquisition unit 604 retrieves the social media information 605 based on the product name attached to the public information request or the product name acquired by the product name acquisition unit 602 so as to acquire public information including the product name (step S104).

After that, the word extraction unit 606 extracts a word included in the public information acquired by the public information acquisition unit 604 (step S105).

Then, the similar word acquisition unit 607 refers to the similar word dictionary (synonym dictionary) 608 based on the word extracted by the word extraction unit 606 so as to acquire a similar word (synonym) (step S106).

Subsequently, the NG word determination unit 609 determines whether or not either one of the word extracted by the word extraction unit 606 and the similar word acquired by the similar word acquisition unit 607 corresponds to an NG word (forbidden word) registered in the NG word dictionary 610 (step S107). Texts which do not include the NG word are held in the publication candidate information 611 and texts which include the NG word are held in the publication exclusion information 612.

Then, the word extraction unit 613 extracts an included word from individual texts of the publication candidate information 611 (step S108).

After that, the similar word acquisition unit 614 refers to the similar word dictionary (synonym dictionary) 608 based on the word extracted by the word extraction unit 613 so as to acquire a similar word (synonym) (step S109).

Next, the superior word determination unit 615 determines whether or not either one of the word extracted by the word extraction unit 613 and the similar word acquired by the similar word acquisition unit 614 corresponds to a superior word (preferential word) registered in the superior word dictionary 616 (step S110). Texts which include the superior word are held in the preferential public information 617 and texts which do not include the superior word are held in the ordinary public information 618.

Subsequently, the screening and processing unit 619 performs screening based on a predetermined pattern with respect to individual texts in the preferential public information 617 and the ordinary public information 618, performs processing such as removal of inappropriate parts, and holds resultant texts in the public information 620 (step S111).

Then, the public information transmission unit 621 transmits the public information 620 with respect to the mobile terminal 4 which has issued the public information request (step S112). The public information reception unit 44 of the mobile terminal 4 receives the public information transmitted from the information provision server 6 in response to the public information request and the public information display unit 45 displays the received public information (step S113).

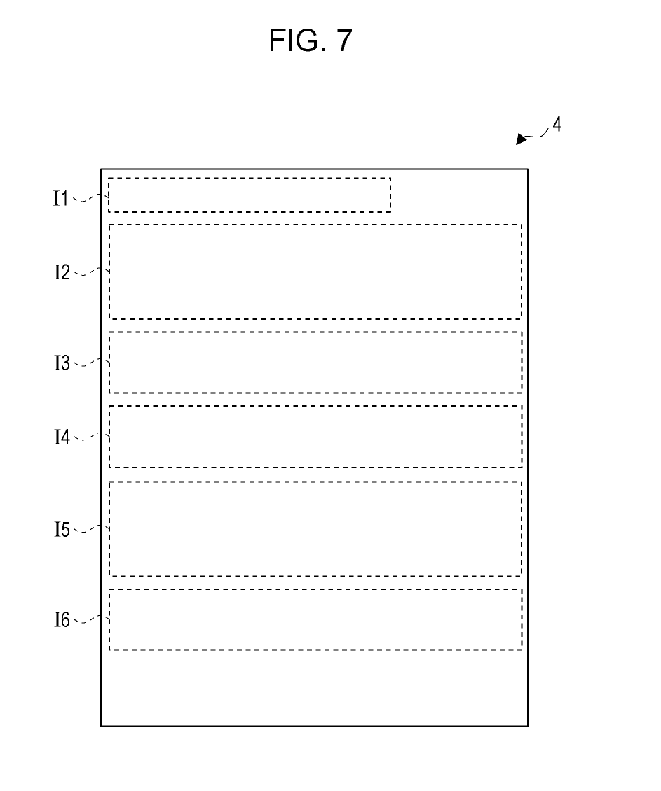

FIG. 7 illustrates a display example of public information in the mobile terminal 4. FIG. 7 illustrates a state that an item I1 representing public information on a product specified by a user and items I2 to I6 corresponding to respective texts of the public information are displayed. In the case where it is difficult to display one or a plurality of texts on one screen, a display range may be changed by a scroll bar or the like.

Here, FIG. 6 illustrates the case where narrowing down to public information not including an NG word and narrowing down to public information including a superior word are consecutively performed, but the processing order may be inverted. Alternatively, only one narrowing down, that is, only narrowing down to public information not including a NG word or only narrowing down to public information including a superior word may be performed.

Further, in the NG word determination (step S107), only determination of whether or not an NG word and a similar word of the NG word is included in each text of public information is performed, but determination may be performed based on weights preset on an NG word and a similar word. In addition, appearance frequency (the number of times of appearance) may be taken into account in the determination, or the determination may be performed based on both weights and the appearance frequency. As a weight of a similar word, a weight of an original NG word may be used or a weight may be independently set. In the case where a weight and appearance frequency are taken into account, a score corresponding to a weight and appearance frequency is calculated with respect to each text and whether or not an NG word is substantively included is determined based on whether or not the score exceeds a predetermined threshold value. Further, the score may be used not only for narrowing down but also for later determination of a display order of public information.

For the superior word determination (step S110) as well, determination may be performed based on weights preset on a superior word and a similar word. In addition, determination may be performed based on appearance frequency (the number of times of appearance) or based on both weights and the appearance frequency.

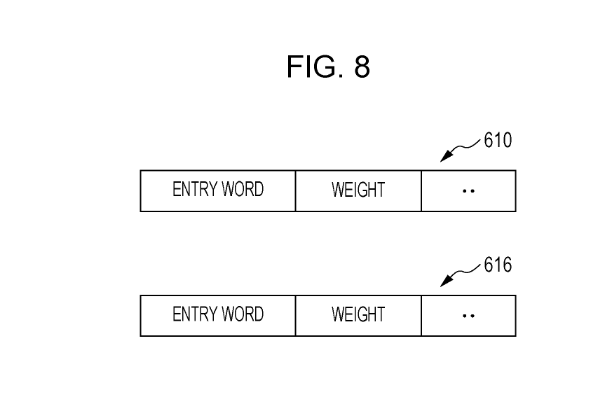

FIG. 8 illustrates an example of imparting weights to dictionaries, in which weights are set in a manner to correspond to entry words in the NG word dictionary 610 and the superior word dictionary 616.

### Second Embodiment

In the second embodiment, public information is preliminarily generated so as to speed up response of public information from the information provision server 6 with respect to a public information request from the mobile terminal 4. Here, the whole system configuration is the same as that illustrated in FIG. 1 and the hardware configurations of respective devices are the same as those illustrated in FIG. 4 and FIG. 5.

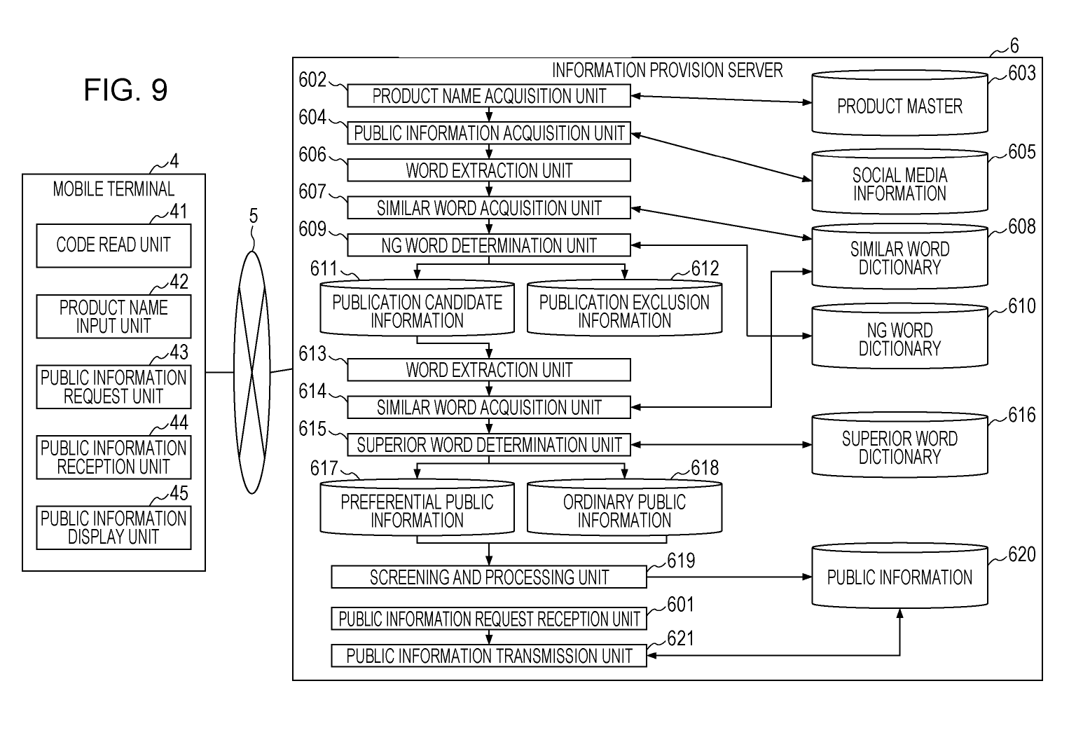

FIG. 9 illustrates a functional configuration example of the mobile terminal 4 and the information provision server 6 according to the second embodiment. FIG. 9 is different from FIG. 2 in that the processing of the product name acquisition unit 602 to the processing of the screening and processing unit 619 are preliminarily executed so as to produce the public information 620, and texts are provided from the public information 620 when the public information request reception unit 601 receives a public information request from the mobile terminal 4. To the product name acquisition unit 602, a function for acquiring product names, which may be provision objects, one by one among products registered in the product master 603 and passing the product names to subsequent processing is added. Further, since the processing of the screening and processing unit 619 is not real-time processing, the processing of the screening and processing unit 619 may be manually performed without limiting to automation. Functions of other units (including complemented functions) are the same as those illustrated in FIG. 2 and various types of information used for processing are the same as those illustrated in FIG. 3.

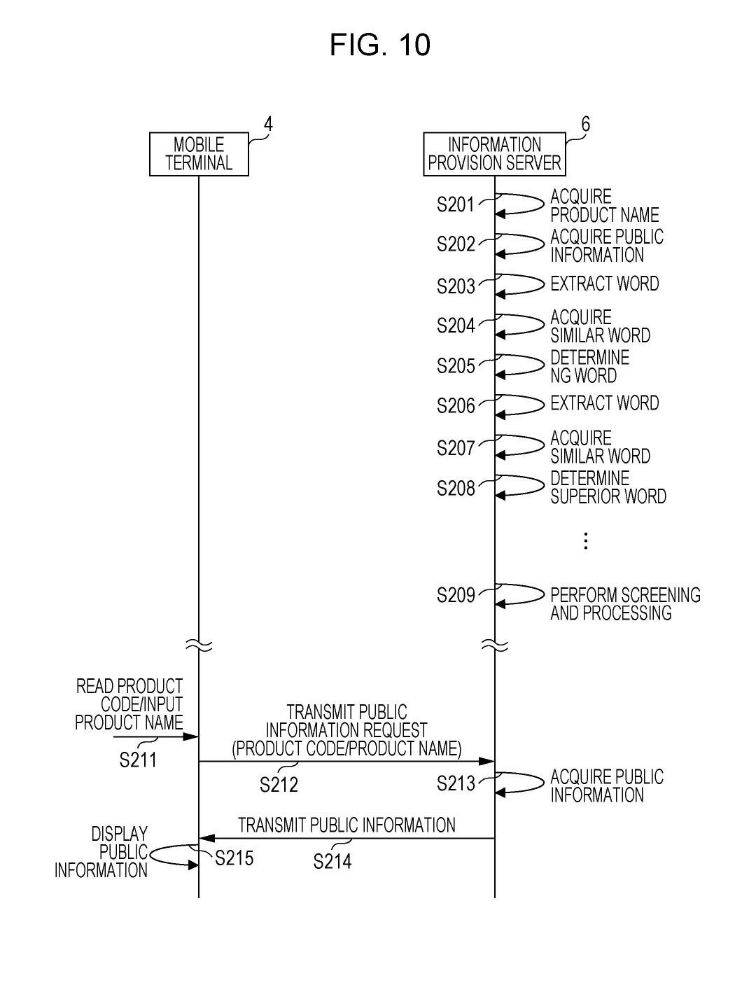

FIG. 10 is a sequence diagram illustrating a processing example according to the second embodiment. In FIG. 10, the product name acquisition unit 602 refers to the product master 603 so as to acquire one product name in a foreign language (Chinese, for example) which is preliminarily translated (step S201).

Subsequently, the public information acquisition unit 604 retrieves the social media information 605 based on the product name acquired by the product name acquisition unit 602 so as to acquire public information including the product name (step S202).

Then, the word extraction unit 606 extracts a word included in the public information acquired by the public information acquisition unit 604 (step S203).

After that, the similar word acquisition unit 607 refers to the similar word dictionary (synonym dictionary) 608 based on the word extracted by the word extraction unit 606 so as to acquire a similar word (synonym) (step S204).

Next, the NG word determination unit 609 determines whether or not either one of the word extracted by the word extraction unit 606 and the similar word acquired by the similar word acquisition unit 607 corresponds to an NG word (forbidden word) registered in the NG word dictionary 610 (step S205). Texts which do not include the NG word are held in the publication candidate information 611 and texts which include the NG word are held in the publication exclusion information 612.

Then, the word extraction unit 613 extracts an included word from individual texts of the publication candidate information 611 (step S206).

After that, the similar word acquisition unit 614 refers to the similar word dictionary (synonym dictionary) 608 based on the word extracted by the word extraction unit 613 so as to acquire a similar word (synonym) (step S207).

Subsequently, the superior word determination unit 615 determines whether or not either one of the word extracted by the word extraction unit 613 and the similar word acquired by the similar word acquisition unit 614 corresponds to a superior word (preferential word) registered in the superior word dictionary 616 (step S208). Texts which include the superior word are held in the preferential public information 617 and texts which do not include the superior word are held in the ordinary public information 618.

The above-described processing is repeated as many times as the number of product names that may be provision objects, among products registered in the product master 603.

After that, the screening and processing unit 619 performs manual screening or screening based on a predetermined pattern with respect to individual texts in the preferential public information 617 and the ordinary public information 618, performs processing such as removal of inappropriate parts, and holds resultant texts in the public information 620 (step S209).

In a practical operation, in response to an operation through the mobile terminal 4 by a foreign user who wants public information at the store 1, the code read unit 41 reads the code image 3 attached to the product 2 by using a camera function so as to acquire a product code. Further, the product name input unit 42 receives an input of a product name from the user instead of code reading (step S211).

Then, the public information request unit 43 transmits a public information request accompanied with the product code acquired by the code read unit 41 or the product name received by the product name input unit 42 with respect to the information provision server 6 (step S212).

When the public information request reception unit 601 of the information provision server 6 receives the public information request, the public information transmission unit 621 acquires corresponding texts from the public information 620 based on the product code or the product name attached to the public information request (step S213). Then, the public information transmission unit 621 transmits the public information with respect to the mobile terminal 4 which has issued the public information request (step S214). The public information reception unit 44 of the mobile terminal 4 receives the public information transmitted from the information provision server 6 in response to the public information request and the public information display unit 45 displays the received public information (step S215). A display example of the public information is the same as that illustrated in FIG. 7.

### Third Embodiment

In the third embodiment, the first embodiment is expanded so that it is possible to provide not only public information in a language (foreign language) used by a user but also public information in an official language of a country where a store exists. Here, the whole system configuration is the same as that illustrated in FIG. 1 and the hardware configurations of respective devices are the same as those illustrated in FIG. 4 and FIG. 5.

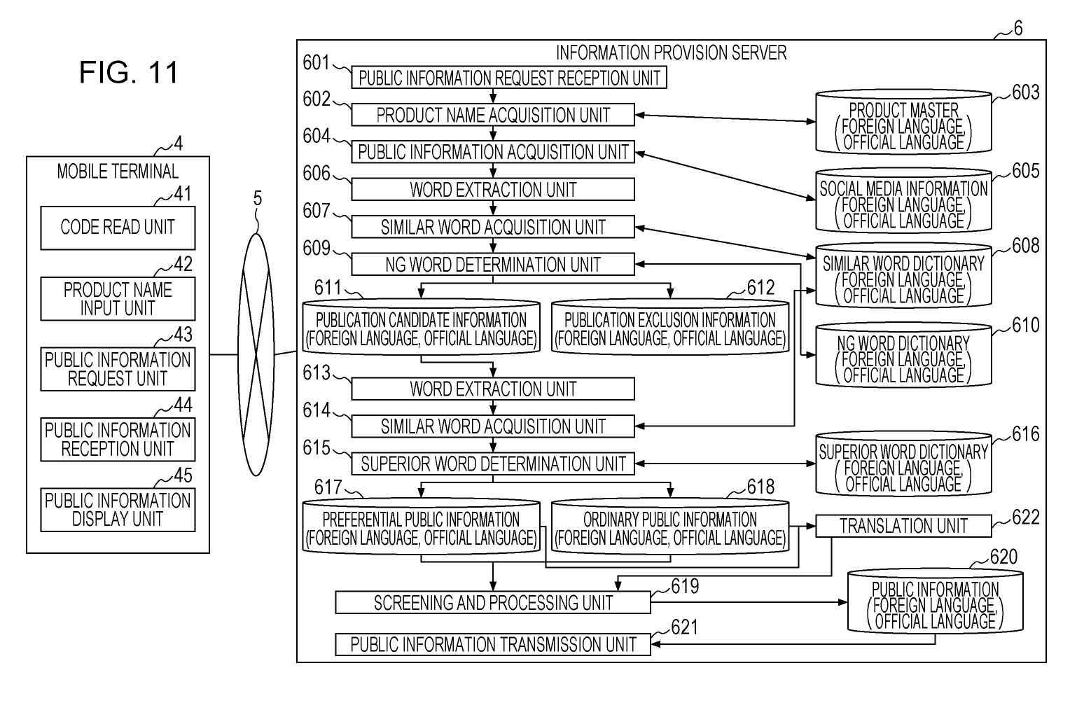

FIG. 11 illustrates a functional configuration example of the mobile terminal 4 and the information provision server 6 according to the third embodiment. FIG. 11 is different from FIG. 2 in that the social media information 605 which is a processing object is not only information based on a foreign language (Chinese, for example) but also information based on an official language (Japanese, for example) and processing is performed with respect to each of texts in the foreign language and texts in the official language. Further, a translation unit 622 is newly provided so as to translate public information based on an official language into information based on a language used by a user.

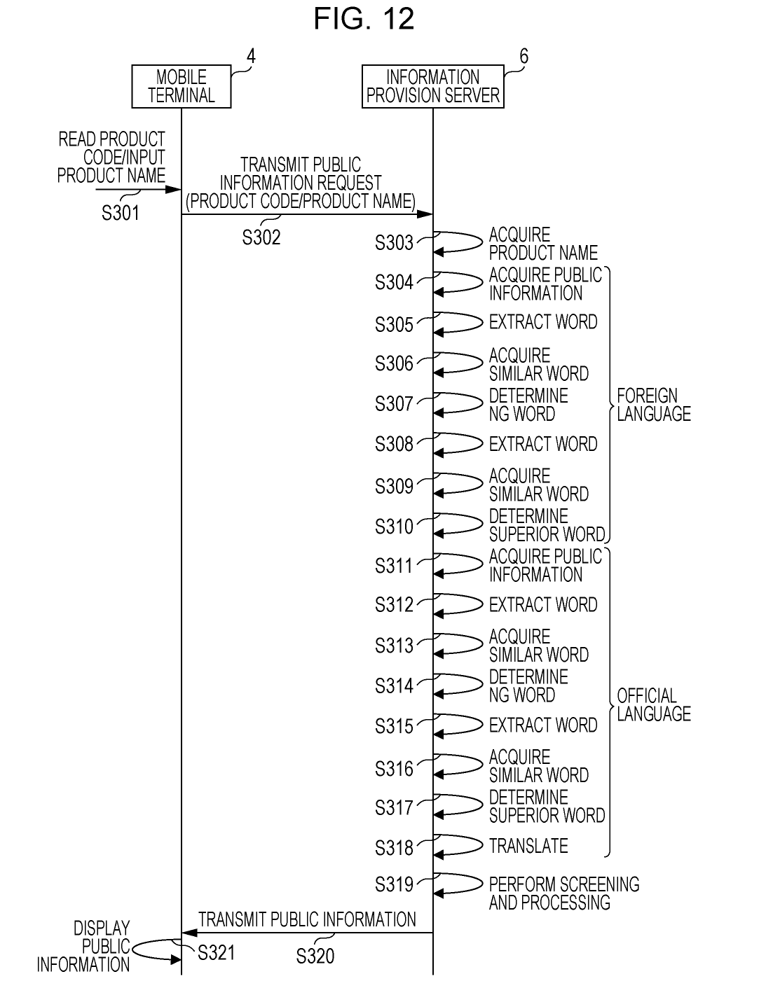

FIG. 12 is a sequence diagram illustrating a processing example according to the third embodiment. In FIG. 12, in response to an operation through the mobile terminal 4 by a foreign user who wants public information at the store 1, the code read unit 41 reads the code image 3 attached to the product 2 by using a camera function so as to acquire a product code. Further, the product name input unit 42 receives an input of a product name from the user instead of code reading (step S301).

Then, the public information request unit 43 transmits a public information request accompanied with the product code acquired by the code read unit 41 or the product name received by the product name input unit 42 with respect to the information provision server 6 (step S302).

When the public information request reception unit 601 receives the public information request, in the case where the public information request is accompanied with the product code, the product name acquisition unit 602 refers to the product master 603 so as to acquire a product name in a foreign language (Chinese, for example) which is preliminarily translated and a product name in an official language (Japanese, for example). In the case where the public information request is accompanied with the product name (foreign language), the product name acquisition unit 602 refers to the product master 603 so as to acquire a product name in a corresponding official language (step S303).

Subsequently, the public information acquisition unit 604 retrieves a foreign language part in the social media information 605 based on the product name in the foreign language between the acquired product names in the foreign language and the official language so as to acquire public information including the product name (step S304).

After that, the word extraction unit 606 extracts a word included in the public information acquired by the public information acquisition unit 604 (step S305).

Then, the similar word acquisition unit 607 refers to the similar word dictionary (synonym dictionary) 608 based on the word extracted by the word extraction unit 606 so as to acquire a similar word (synonym) in the foreign language (step S306).

Next, the NG word determination unit 609 determines whether or not either one of the word extracted by the word extraction unit 606 and the similar word acquired by the similar word acquisition unit 607 corresponds to an NG word (forbidden word) registered in the NG word dictionary 610 (step S307). Texts which do not include the NG word are held in a foreign language part in the publication candidate information 611 and texts which include the NG word are held in a foreign language part in the publication exclusion information 612.

Then, the word extraction unit 613 extracts an included word from individual texts of the foreign language part in the publication candidate information 611 (step S308).

After that, the similar word acquisition unit 614 refers to the similar word dictionary (synonym dictionary) 608 based on the word extracted by the word extraction unit 613 so as to acquire a similar word (synonym) in the foreign language (step S309).

Subsequently, the superior word determination unit 615 determines whether or not either one of the word extracted by the word extraction unit 613 and the similar word acquired by the similar word acquisition unit 614 corresponds to a superior word (preferential word) registered in the superior word dictionary 616 (step S310). Texts which include the superior word are held in a foreign language part in the preferential public information 617 and texts which do not include the superior word are held in a foreign language part in the ordinary public information 618.

Subsequently, the public information acquisition unit 604 retrieves the official language part in the social media information 605 based on the product name in the official language so as to acquire public information including the product name (step S311).

After that, the word extraction unit 606 extracts a word included in the public information acquired by the public information acquisition unit 604 (step S312).

Then, the similar word acquisition unit 607 refers to the similar word dictionary (synonym dictionary) 608 based on the word extracted by the word extraction unit 606 so as to acquire a similar word (synonym) in the official language (step S313).

Next, the NG word determination unit 609 determines whether or not either one of the word extracted by the word extraction unit 606 and the similar word acquired by the similar word acquisition unit 607 corresponds to an NG word (forbidden word) registered in the NG word dictionary 610 (step S314). Texts which do not include the NG word are held in an official language part in the publication candidate information 611 and texts which include the NG word are held in an official language part in the publication exclusion information 612.

Then, the word extraction unit 613 extracts an included word from individual texts of the publication candidate information 611 (step S315).

After that, the similar word acquisition unit 614 refers to the similar word dictionary (synonym dictionary) 608 based on the word extracted by the word extraction unit 613 so as to acquire a similar word (synonym) in the official language (step S316).

Subsequently, the superior word determination unit 615 determines whether or not either one of the word extracted by the word extraction unit 613 and the similar word acquired by the similar word acquisition unit 614 corresponds to a superior word (preferential word) registered in the superior word dictionary 616 (step S317). Texts which include the superior word are held in an official language part in the preferential public information 617 and texts which do not include the superior word are held in an official language part in the ordinary public information 618.

Then, the translation unit 622 translates texts held in the official language parts in the preferential public information 617 and the ordinary public information 618 into texts in a foreign language used by a user (step S318). The public information translated into the foreign language is temporarily held.

Here, it has been assumed that the processing for the official language is performed subsequent to the processing for the foreign language, but the processing order may be inverted or these processing may be performed in parallel.

Subsequently, the screening and processing unit 619 performs screening based on a predetermined pattern with respect to individual texts in the foreign language in the preferential public information 617 and the ordinary public information 618 and the texts translated into the foreign language and performs processing such as removal of inappropriate parts. Then, the screening and processing unit 619 holds resultant texts in the public information 620 (step S319). The texts to be held are separated into texts acquired from the public information in the foreign language and texts acquired from the public information in the official language.

Then, the public information transmission unit 621 transmits the public information 620 with respect to the mobile terminal 4 which has issued the public information request (step S320). The public information reception unit 44 of the mobile terminal 4 receives the public information transmitted from the information provision server 6 in response to the public information request and the public information display unit 45 displays the received public information (step S321).

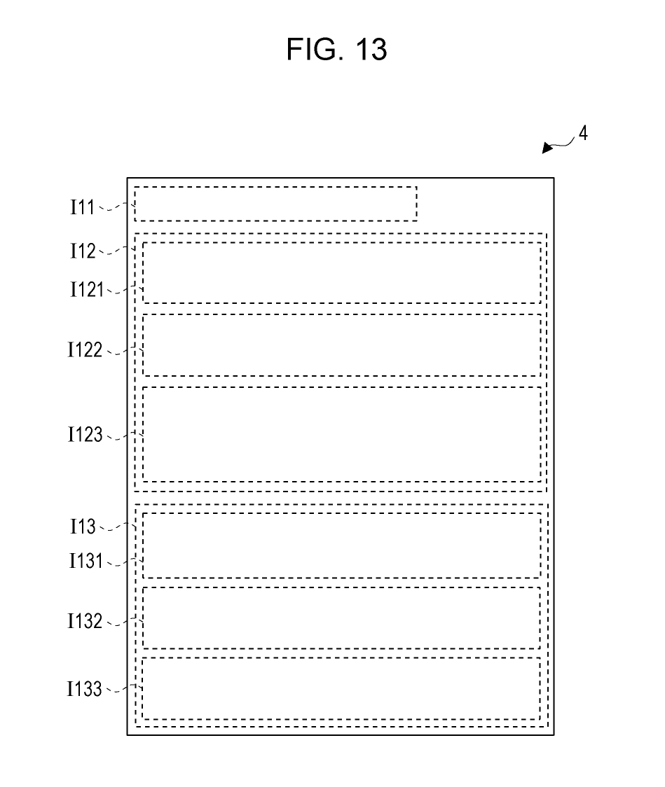

FIG. 13 illustrates a display example of public information in the mobile terminal 4, in which an item I11 representing public information on a specified product, an item group I12 of texts acquired from public information based on a foreign language, and an item group I13 of texts acquired from public information based on an official language are separated from each other. In the item group I12, items I121 to I123 corresponding to texts are included. In the item group I13, items I131 to I133 corresponding to texts are included. Here, in the case where it is difficult to display one or a plurality of texts on one screen, a display range may be changed by a scroll bar or the like.

In the NG word determination and the superior word determination, weights (FIG. 8) may be taken into account and appearance frequency may also be taken into account as described above. In this case, regarding setting of weights, it may be set that differences in national characters and the like between general foreigners who use the same foreign language as that of a user and general public using an official language are taken into account. For example, if there are circumstances in which general foreigners are very strict about price more than quality while the general public using the official language is very strict about quality of products, different weights are set for corresponding NG words and superior words. Accordingly, texts will be collected that matches a sense of a foreign user even acquired from public information in the official language, thus improving a value as provided information.

### Fourth Embodiment

In the fourth embodiment, the second embodiment is expanded so that it is possible to provide not only public information in a language (foreign language) used by a user but also public information in an official language of a country where a store exists. Here, the whole system configuration is the same as that illustrated in FIG. 1 and the hardware configurations of respective devices are the same as those illustrated in FIG. 4 and FIG. 5.

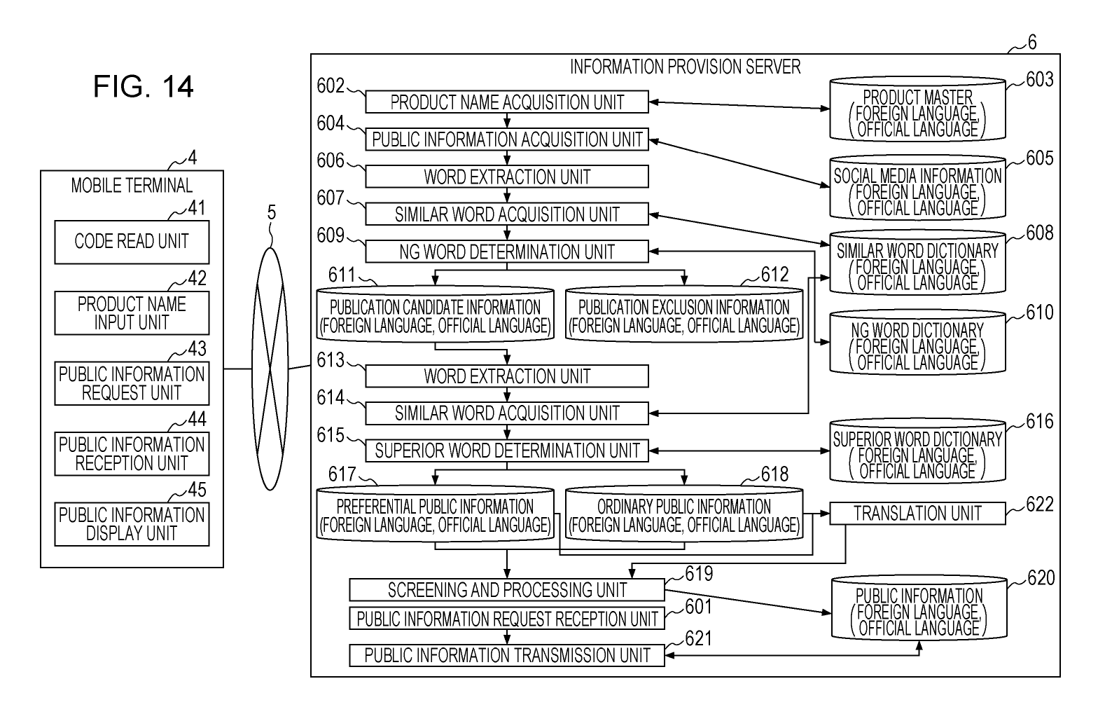

FIG. 14 illustrates a functional configuration example of the mobile terminal 4 and the information provision server 6 according to the fourth embodiment. FIG. 14 is different from FIG. 9 in that the social media information 605 which is a processing object is not only information based on a foreign language (Chinese, for example) but also information based on an official language (Japanese, for example) and processing is performed with respect to each of texts in the foreign language and texts in the official language. Further, a translation unit 622 is newly provided so as to translate public information based on an official language into information based on a language used by a user.

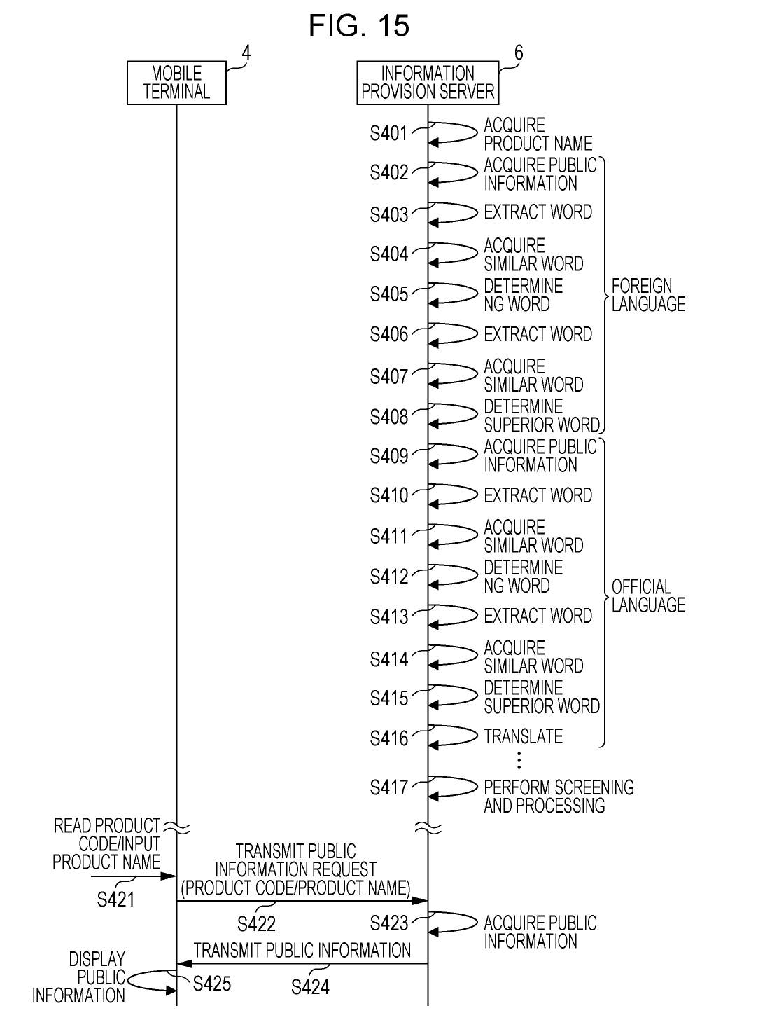

FIG. 15 is a sequence diagram illustrating a processing example according to the fourth embodiment. In FIG. 15, the product name acquisition unit 602 refers to the product master 603 so as to acquire one product name in a foreign language (Chinese, for example) which is preliminarily translated and one product name in an official language (Japanese, for example) (step S401).

Subsequently, the public information acquisition unit 604 retrieves a foreign language part in the social media information 605 based on the product name in the foreign language acquired by the product name acquisition unit 602 so as to acquire public information including the product name (step S402).

After that, the word extraction unit 606 extracts a word included in the public information acquired by the public information acquisition unit 604 (step S403).

Then, the similar word acquisition unit 607 refers to the similar word dictionary (synonym dictionary) 608 based on the word extracted by the word extraction unit 606 so as to acquire a similar word (synonym) in the foreign language (step S404).

Next, the NG word determination unit 609 determines whether or not either one of the word extracted by the word extraction unit 606 and the similar word acquired by the similar word acquisition unit 607 corresponds to an NG word (forbidden word) registered in the NG word dictionary 610 (step S405). Texts which do not include the NG word are held in a foreign language part in the publication candidate information 611 and texts which include the NG word are held in a foreign language part in the publication exclusion information 612.

Then, the word extraction unit 613 extracts an included word from individual texts of the foreign language part in the publication candidate information 611 (step S406).

After that, the similar word acquisition unit 614 refers to the similar word dictionary (synonym dictionary) 608 based on the word extracted by the word extraction unit 613 so as to acquire a similar word (synonym) in the foreign language (step S407).

Subsequently, the superior word determination unit 615 determines whether or not either one of the word extracted by the word extraction unit 613 and the similar word acquired by the similar word acquisition unit 614 corresponds to a superior word (preferential word) registered in the superior word dictionary 616 (step S408). Texts which include the superior word are held in a foreign language part in the preferential public information 617 and texts which do not include the superior word are held in a foreign language part in the ordinary public information 618.

Subsequently, the public information acquisition unit 604 retrieves an official language part in the social media information 605 based on the product name in the official language acquired by the product name acquisition unit 602 so as to acquire public information including the product name (step S409).

The word extraction unit 606 extracts a word included in the public information acquired by the public information acquisition unit 604 (step S410).

After that, the similar word acquisition unit 607 refers to the similar word dictionary (synonym dictionary) 608 based on the word extracted by the word extraction unit 606 so as to acquire a similar word (synonym) in the official language (step S411).

Next, the NG word determination unit 609 determines whether or not either one of the word extracted by the word extraction unit 606 and the similar word acquired by the similar word acquisition unit 607 corresponds to an NG word (forbidden word) registered in the NG word dictionary 610 (step S412). Texts which do not include the NG word are held in an official language part in the publication candidate information 611 and texts which include the NG word are held in an official language part in the publication exclusion information 612.

Then, the word extraction unit 613 extracts an included word from individual texts of the official language part in the publication candidate information 611 (step S413).

After that, the similar word acquisition unit 614 refers to the similar word dictionary (synonym dictionary) 608 based on the word extracted by the word extraction unit 613 so as to acquire a similar word (synonym) in the official language (step S414).

Subsequently, the superior word determination unit 615 determines whether or not either one of the word extracted by the word extraction unit 613 and the similar word acquired by the similar word acquisition unit 614 corresponds to a superior word (preferential word) registered in the superior word dictionary 616 (step S415). Texts which include the superior word are held in an official language part in the preferential public information 617 and texts which do not include the superior word are held in an official language part in the ordinary public information 618.

Then, the translation unit 622 translates texts held in the official language parts in the preferential public information 617 and the ordinary public information 618 into texts in a foreign language used by a user (step S416). The public information translated into the foreign language is temporarily held.

Here, it has been assumed that the processing for the official language is performed subsequent to the processing of the foreign language, but the order may be inverted or these processing may be performed in parallel.

The above-described processing is repeated as many times as the number of product names that may be provision objects, among products registered in the product master 603.

After that, the screening and processing unit 619 performs manual screening or screening based on a predetermined pattern with respect to individual texts based on the foreign language in the preferential public information 617 and the ordinary public information 618 and the texts translated into the foreign language and performs processing such as removal of inappropriate parts. Then, the screening and processing unit 619 holds resultant texts in the public information 620 (step S417).

In practical operation, in response to an operation through the mobile terminal 4 by a foreign user who wants public information at the store 1, the code read unit 41 reads the code image 3 attached to the product 2 by using a camera function so as to acquire a product code. Further, the product name input unit 42 receives an input of a product name from the user instead of code reading (step S421).

Then, the public information request unit 43 transmits a public information request accompanied with the product code acquired by the code read unit 41 or the product name received by the product name input unit 42 with respect to the information provision server 6 (step S422).

When the public information request reception unit 601 of the information provision server 6 receives the public information request, the public information transmission unit 621 acquires corresponding texts from the public information 620 based on the product code or the product name attached to the public information request (step S423). Then, the public information transmission unit 621 transmits the public information with respect to the mobile terminal 4 which has issued the public information request (step S424). The public information reception unit 44 of the mobile terminal 4 receives the public information transmitted from the information provision server 6 in response to the public information request and the public information display unit 45 displays the received public information (step S425). A display example of the public information is the same as that illustrated in FIG. 13.

<Modification>

In the above-described embodiments, the case where information is provided to foreign customers (Chinese, for example) who use a specific language (Chinese, for example) has been described, but the multilingual configuration is applicable. That is, by specifying a language on the mobile terminal 4 side or specifying a language at the time of downloading an application for realizing main functions of the mobile terminal 4 side, for example, it is possible to specify a language used by a customer from among a plurality of languages. In this case, when the mobile terminal 4 issues a public information request with respect to the information provision server 6, language specification information is accompanied, and the information provision server 6 narrows down public information based on the specification information. It goes without saying that the product master 603, the social media information 605, the similar word dictionary 608, the NG word dictionary 610, the superior word dictionary 616, and the like are prepared for each language which may be specified on the information provision server 6 side.

<Review>

According to the above-described embodiments, it is possible to appropriately output information corresponding to a product, as described above.

The description has been provided by the preferred embodiments thus far. Though the description has been provided through specific examples, it is obvious that various modifications and alterations may be made to these specific examples without departing from the broader spirit and scope defined in the claims. That is, it is requested not to be construed as being limited by details of the specific examples and the accompanying drawings.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information output method in which a computer is made execute processing comprising:
acquiring a character string corresponding to identification information representing a product when the identification information representing the product is acquired;
collecting information including the character string;
referring to a storage configured to store a forbidden word corresponding to the character string;
specifying information that does not include the forbidden word corresponding to the character string among the information that are collected; and
outputting the information that does not include the forbidden word corresponding to the character string.

2. The information output method according to claim 1, wherein the information is information sent in social media.

3. The information output method according to claim 1, further comprising:
referring to synonym dictionary information; and
extracting a synonym of the forbidden word corresponding to the character string; wherein
the information that does not include the forbidden word corresponding to the character string includes information that does not include the forbidden word corresponding to the character string and the synonym of the forbidden word corresponding to the character string.

4. The information output method according to claim 1, wherein the information that does not include the forbidden word corresponding to the character string is specified based on a weight attached to the forbidden word or appearance frequency of the forbidden word or both of a weight attached to the forbidden word and appearance frequency of the forbidden word.

5. The information output method according to claim 1, further comprising:
collecting information including a word that is before translation and represents the product;
referring to a storage unit that stores a forbidden word in a manner to associate the forbidden word with the word that is before translation and represents the product;
specifying information that does not include the forbidden word corresponding to the word that is before translation and represents the product, among the information that are collected and include the word that is before translation and represents the product; and
outputting the information that does not include the forbidden word corresponding to the word that is before translation and represents the product.

6. The information output method according to claim 5, wherein the information that does not include the forbidden word corresponding to the word that is before translation and represents the product is specified based on a weight attached to the forbidden word or appearance frequency of the forbidden word or both of a weight attached to the forbidden word and appearance frequency of the forbidden word.

7. The information output method according to claim 6, wherein a weight attached to the forbidden word is set in accordance with a language of the character string.

8. The information output method according to claim 1, further comprising:
acquiring language specification information; and
acquiring the character string corresponding to a language represented by the language specification information.

9. An information output apparatus comprising:
a memory; and
a processor coupled to the memory and configured to:
acquire a character string corresponding to identification information representing a product when the identification information representing the product is acquired,
collect information including the character string,
refer to the memory configured to store a forbidden word corresponding to the character string,
specify information that does not include the forbidden word corresponding to the character string among the information that are collected, and
output the information that does not include the forbidden word corresponding to the character string.
